(19) United States
(12) Patent Application Publication
(10) Pub. No.: US 2011/0165542 A1
(43) Pub. Date: Jul. 7, 2011

(54) MULTI-PARAMETER, CUSTOMIZABLE SIMULATION BUILDING SYSTEM FOR CLINICAL SCENARIOS FOR EDUCATING AND TRAINING NURSES AND OTHER HEALTH CARE PROFESSIONALS

(75) Inventors: Suzanne Hetzel Campbell, Newtown, CT (US); Philip A. Greiner, Fairfield, CT (US)

(73) Assignee: FAIRFIELD UNIVERSITY, Fairfield, CT (US)

(21) Appl. No.: 12/985,874

(22) Filed: Jan. 6, 2011

Related U.S. Application Data
(60) Provisional application No. 61/293,042, filed on Jan. 7, 2010.
(60) Provisional application No. 61/293,043, filed on Jan. 7, 2010.

(51) Int. Cl. G09B 19/00

(52) U.S. Cl. 434/219

(57) ABSTRACT

The present invention provides a new and unique technique for providing simulation-based education tools and strategies, including for building a simulation program, such as a simulation program for educating and training nurses and other health care professionals. The simulation technique features a simulation module having one or more database and simulation scenario building modules. The database module is configured to receive inputs or instructions containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals. The database module is also configured to provide information about the selection of one or more simulation parameters. The simulation scenario building module is configured to receive the information about the selection of one or more simulation parameters, and to provide simulation scenario building signaling containing information about one or more customized simulation scenarios built for the customized simulation for educating and training nurses and other health care professionals based at least partly on the selection of the one or more simulation parameters contained in the signaling.

### CROSS-REFERENCE TO RELATED APPLICATION

This application claims benefit to provisional patent application Ser. No. 61/293,043, filed 7 Jan. 2010, which is hereby incorporated by reference in its entirety.

### BACKGROUND OF THE INVENTION

1. Field of Invention

This invention relates to simulation-based education tools and strategies; and more particularly relates to a new method for building flexible, multi-parametered simulation scenarios, including a suite of programs for educating and training nurses and other health care professionals.

2. Description of Related Art

Current products known in the art do not allow for a seamless creation of flexible or customizable simulation scenarios that provide operational integration and evaluation of simulations to the extent envisioned in this product. One type of existing simulation is computer-assisted instruction that includes live interaction with a simulated patient and decision making regarding care in a 3-dimensional format. These programs provide feedback to help students learn about the accuracy of their thinking and actions. Examples of these computer-assisted simulations include: MicroSim Inhospital® (Laerdal/Medical, http://laerdal.com/nav/21475622/MicroSim.html), SimClinic® (Elsevier, see http://www.elsevier.com/wps/find/bookdescription.cws_home/704525/description#description), and Virtual IV® (Engum & Jeffries, 2003).

Book publishers now offer options to enhance simulation such as Elsevier/Mosby/Saunder's “Virtual Clinical Excursions” for Adult Health (see an example at: http://www.elsevier.com/wps/find/bookdescription.librarians/707251/description) and “Simulation Learning Systems”, see a review at: http://www.reed-elsevier.com/brands/scienceandmedical/Pages/SimulationLearningSystem.aspx and Pearson's “Real Nursing Simulations” (http://vig.pearsonhighered.com/educator/academic/product/0,3110,0135042488,00.html).

These approaches to simulation-based pedagogy can be used separately at a simulation center, or incorporated into a hybrid course on line; used in the classroom prior to a case study, or assigned in preparation for a simulation experience. The plethora of materials requires nurse educators to keep up with what is available to supplement planned clinical simulation activities, and faculty need to remember to keep in mind the learning objectives and desired outcomes. Furthermore, available simulations are static scenarios that offer little if any flexibility in executing a given scenario. Therefore, faculty are required to adapt their teaching objectives to available simulations.

Electronic health record (EHR) use and its relationship to patient safety and staff efficiency/vigilance, as well as the role of the nurse in EHR use, has been documented (Valentine, 2005; Weir, Hoffman, Nebeker, & Hurdle, 2005). Some nursing programs are experimenting with the use of EHRs as a teaching tool to enhance clinical simulation. These scenarios provide students with in-depth information that adds to the realism of the experience. Students also gain practice navigating the software systems and learn to record their findings in this efficient and effective way. Individual communities or records have been created by faculty members using university or medical center resources to document the results of EHR in-class use (Donahue & Thiede, 2006; Fauchald, 2008; Sheets, 2006). These records have been created for one time use and are static, as compared to the proposed product with its dynamic, multi-parametered front-end.

In addition, Cerner® Corporation has developed “Academic Education Solutions” (http://www.cerner.com/public/Cerner_{—}3.asp?id=29911), a clinical information system similar to that used in hospitals and clinics throughout the country. While other products, such as the publisher simulation systems mentioned above, contain EHRs, they are static with pre-packaged content. Another web-accessible program is NurseSquared, a simulated EHR with embedded scenarios (http://www.nursesquared.com/). Similarities between these systems are that they provide more concrete use of clinical informatics, integrating simulation experiences with clinical information systems, thereby enhancing the clinical “realism” of scenarios. This exposes faculty members and students to clinical informatics beyond just web-enhanced courses, and meets the prescription for innovative teaching using technology. A survey by National League for Nursing (2008), found that “Personal digital assistants (PDAs), software for care plans, and clinical information systems were the least likely to be incorporated into courses . . . suggest(ing) that little clinical informatics content or learning experiences are included in registered nurse programs” (p. 4).

Further, there are known software programs designed to streamline the evaluation process. For example, Education Management Solutions (EMS) provides integrated clinical skills assessment software that incorporates audio-visual systems to provide simulation training center management solutions. This software digitally captures audio and video of scenarios, allowing faculty to bookmark, debrief, remediate, fill out checklists electronically and generate performance evaluation reports. In addition both the hardware and software integrate with patient simulators, standardized patients and virtual reality applications (www.ems-works.com). This is an example of resources for schools of nursing to incorporate simulation into clinical education. In spite of this, there is a need to better demonstrate the connection between simulation education and student learning to rationalize the cost in resources, faculty time, and student expenses.

In conclusion, the known clinical simulation techniques typically provide for a “task trainer” of some kind. In other words, known techniques cover approaches to teaching medical related tasks and a simulated means to practice treatment techniques and/or learn medical procedures. These known techniques typically involve a specific machine or device of some sort.

Other references of interest include:
Donahue, B., & Thiede, K. (2006, June). Integrating the electronic health record into high fidelity clinical simulations. Paper presented at the 11th Biennial North American Learning Resource Centers Conference: Nursing Education on the Move: Technology, Creativity, and Innovation, Philadelphia, Pa.
Engum, S., & Jeffries, P. (2003). Intravenous catheter training system: Computer-based education vs. traditional learning methods. The American Journal of Surgery, 186, 67-74.
Fauchald, S. K. (2008). CIN Plus. An academic-industry partnership for advancing technology in health science education. CIN: Computers, Informatics, Nursing, 26, 4-8.
Sheets, D. (2006, June). Using a CIS format for case studies in classroom and simulated lab. Paper presented at the 11th Biennial North American Learning Resource Centers Conference: Nursing Education on the Move: Technology, Creativity, and Innovation., Philadelphia, Pa.
Valentine, K. (2005). Electronic medical records promote caring and enhance professional vigilance. International Journal for Human Caring, 9, 121.
Weir, C., Hoffman, J., Nebeker, J., & Hurdle, J. (2005). Nurse's role in tracking adverse drug events: The impact of provider order entry. Nursing Administration Quarterly, 29, 39-44.

### SUMMARY OF THE INVENTION

### The Basic Invention

The present invention provides a new and unique method for providing and applying simulation-based education tools and pedagogical strategies, used for pre-licensure education and continuing healthcare professional education, training, and quality control in academic and clinical settings.

Just as airline pilots are required to train on simulators to learn and polish their skills and build experience; and just as lawyers go through simulated courtroom training (i.e. Moot Court) to learn their craft and build both experience and confidence; so too should health care professionals learn and reinforce their craft and build their experience and confidence through simulated training. The innovative technique has applications for educating and training nursing students, nursing professionals, medical assistants, among others health professionals who provide primary patient care.

One novel aspect of the present invention relates to a unique way in which faculty/instructors can build customized simulation scenarios that align with whatever learning objectives are of interest to the faculty at the time. The ability to build and control customized simulation scenarios contrasts sharply with existing simulation systems that utilize fixed or static simulation scenarios where faculty and clinical educators must rely on pre-packaged simulations. In other words, the present invention gives control of the scenario design and learning objectives to the faculty; thereby empowering faculty to create simulations that fit his/her particular teaching objectives rather than having to modify teaching objectives to fit available simulations.

The present invention also provides faculty and clinical educators the ability to build and constantly modify customized scenarios by selecting from an array of parameters presented on a “Simulation Dashboard.” This invention details a new, automated simulation paradigm for education and training in which simulations are created, performance is assessed, and performance feedback is used to build subsequent, sequential simulation scenarios to challenge students with increasingly complicated scenarios.

The present invention is captured in this simulation paradigm and simulation dashboard that allow faculty to build customized and versatile simulations. The use of a database of actual patient data is integral to the simulation paradigm. However, contrived patient data records can also be incorporated in simulation scenarios. Additionally, the present invention may also be adapted in relation to the use of Human Patient Simulators (HPS) is part of the simulation paradigm.

The present invention may also be adapted in relation to being web-enabled so that simulations can be created, uploaded, and accessed remotely. Simulations can be carried out remotely via computer or in near real-time for performance assessment, so subsequent sequential simulations of increasing complexity can be attempted once prerequisite simulations are satisfactorily performed. All this can be accomplished completely independent of the instructor's involvement—once the instructor has built and uploaded the simulation and associated learning objectives. All simulation data can then be retrieved and analyzed in a face to face teaching environment.

The present invention provides faculty new and exciting tools to translate their own learning objectives directly into a simulation scenario that will link precisely to unique class and clinical requirements. Faculty can choose from a database of real and contrived patients the age, ethnicity, co-morbidity, sex, primary diagnosis, etc of the patient; from this selected case, they develop the actual simulation, identifying student roles, scripts, necessary equipment, mulage, and other artifacts needed for added realism. In addition, development of the student evaluation methods, event logs, and debriefing questions could be accomplished. The result is an innovative simulation-based curriculum that will align with a multitude of teaching objectives and provide immediate feedback to students and instructors

Another unique contribution of the present invention to the state of the art is its user-friendly front end dashboard that allows the faculty to assemble components into a coherent whole, allowing for a variety of different scenarios to be built and potential learning outcomes to be assessed.

The present invention is adaptable to the integration of electronic health records (EHR) linked to the database, which is a critical component. Two aspects linking the product to EHRs will be the ability to save EHRs by student name (rather than patient name), and the ability of faculty to retrieve EHRs by student name. The present invention will allow schools of nursing to meet new BSN Essential requirements for the use of clinical informatics and innovative teaching with technology.

The present invention provides a comprehensive clinical education, simulation-linked system focused on patient and care coordination management for clinical providers. In other words, whereas the known techniques focus on task training, the technique according to the present invention focuses on educating and training clinical providers in patient and care coordination management using customizable simulations that draw on a database of actual (or contrived) patient data.

The overall simulation-based education paradigm, as well as certain individual components of the system, according to the present invention, offer the following unique features:
a simulation dashboard for creating customized scenarios to teach and reinforce learning objectives and to follow established care protocols;
an option for multiple methods for simulation to interface with student and/or clinical providers (i.e. physical interfaces and virtual interfaces);
an automatic (programmable) feedback that can enable a cascade of enhanced scenario variables to be introduced in an iterative manner based on the successful completion of prior simulations in the series, and,
automated and flexible assessment strategies.

### A Simulation Module for Building Scenarios

In particular, according to some embodiments, the present invention may take the form of a simulation module for building scenarios that may comprise one or more database modules in combination with one or more simulation scenario building modules.

The one or more database modules may be configured to receive inputs or instructions, e.g. from the simulation dashboard, about a selection of one or more simulation scenario parameters stored therein, chosen by a simulation scenario builder and based on some combination of personal preferences and specific teaching or learning objectives for building a customized simulation for educating and training of nurses and other health care professionals. The one or more database modules may also be configured to provide data from the database module containing information about the selection of one or more simulation scenario parameters. The simulation scenario builder may include, for example, faculty, instructors or clinical educators, quality assurance managers, performance managers.

The one or more simulation scenario building modules may be configured to receive the data from the database module and also provide simulation scenario building information about one or more customized simulation scenarios built for the customized simulation for educating and training of nurses and other health care professionals based at least partly on the selection of the one or more simulation parameters contained in the inputs or instructions, e.g. from the simulation dashboard.

The simulation module may be connected to one or more terminals for building the customized simulation scenarios, e.g. by the simulation scenario builder, as well as for conducting customized simulation scenarios e.g. by the simulation builder, including the student. By way of example, the connection may include a wired, wireless and/or Internet connection.

### The Database Module

According to some embodiments, the one or more database modules may include a simulation customization dashboard database that may be configured to store the simulation parameters to be chosen by the simulation scenario builder and based on some combination of the personal preferences and specific teaching or learning objectives for building the customized simulation. The simulation customization dashboard database may be configured to store real patient data as well as contrived patient data, which may form part of the information provided from the one or more database modules to the one or more simulation scenario building modules.

### The Simulation Dashboard Module

According to some embodiments, the one or more simulation scenario building modules may comprise a simulation dashboard module configured to provide a graphical user interface that may include providing menu-based information about one or more requests for the selection of simulation parameters to be chosen by the simulation scenario builder, and receiving in response thereto customized simulation building user-input information about the one or more requests for the selection of simulation parameters chosen by the simulation scenario builder.

The one or more simulation scenario building modules may also comprise a customized simulation scenario database configured to store the simulation scenario building information about the one or more customized simulation scenarios built for the customized simulation.

The one or more simulation scenario building modules may be configured to receive further customized simulation scenario building information about adjusting or modifying one or more previously built customized simulation scenarios, and to provide further simulation scenario building information about one or more adjusted or modified customized simulation scenarios, including additional challenges, built for the customized scenario based at least partly on the further customized simulation scenario building information.

The one or more simulation scenario building modules may be configured to receive associated information about adjusting the prepared or customized simulation scenario, and to determine a sequential customized simulation scenario based at least partly on the associated information.

The one or more simulation scenario building modules may be configured to determine customized simulation scenarios that include a set of sequential customized simulation scenarios having increasingly complicated simulation scenarios.

The one or more simulation scenario building modules may also be configured to exchange signaling containing information with the one or more database modules.

### A Simulation Presentation Module

According to some embodiments, the simulation module may comprise one or more simulation presentation modules configured to provide customized simulation scenarios information to present the customized simulation scenarios when conducting a simulation. The one or more simulation presentation modules may be configured to provide the customized simulation scenarios in the simulation to one or more students in real time during class or over the Internet.

The one or more simulation presentation modules may be configured to receive simulation scenario feedback information about a response to the one or more customized simulation scenarios being presented in the simulation. The simulation scenario feedback information may be evaluated in real time during class or during a subsequent review. The one or more simulation presentation modules are configured to conduct the one or more adjusted or modified customized simulation scenarios immediately or in the future for further assessment. The one or more simulation presentation modules may be configured to be web enabled to upload the customized simulation scenarios for remote access, including via a remote computer. The customized simulation scenario information may contain information as input to a Human Patient Simulator (HPS). The customized simulation scenario information may contain information about some combination of development of student evaluation methods, event logs and debriefing questions. The one or more simulation presentation modules may be configured to retrieve simulation data for analysis, including in a face-to-face teaching environment.

### Simulation Parameters

According to some embodiments, the list of simulation parameters may include, by way of example, some combination of a level of nurse training, a parameter related to an age of a patient, one or more clinical parameters of the patient, one or more social parameters of the patient, one or more care facility parameters, a level of support available, a care circumstance, disease categories or parameters, simulation objectives, or a case selection. The level of nurse training includes a pre-licensure category which includes 1^{st} level or 2nd level nursing student, and a licensed practitioner category that will include new employee/resident, competency-maintenance, or competency-new area. The parameter related to an age of the patient includes neonate, pediatric, adolescent, young adult, middle age, near elderly, elderly. The one or more clinical parameters of the patient may include, by way of example, verbal/non-verbal, conscious/unconscious, know/unknown history, chronic/acute condition, known/unknown diagnosis. The one or more social parameters of the patient may include, by way of example, some combination of English/non-English speaking, indigent, cooperative/uncooperative. The one or more care facility parameters may include, by way of example, some combination of a teaching hospital, a suburban hospital, an emergency clinic, ambulatory, long term care/rehabilitation and home care. The level of support available includes, by way of example, some combination of paraprofessional and professional support. The care circumstance may include, by way of example, some combination of a single patient, multiple patients, emergency care, in-patient care, critical care and triage. The health and illness parameters include some combination of disease and situation specific conditions such as: medication/substance abuse; medical/surgical issues; psychiatric mental health issues; specialized conditions and population specific issues. The simulation objectives may include, by way of example, some combination of assessment, comfort, diagnosis, management, hand-off and education of patient and/or their families. The care selection may include, by way of example, a system that provides a suite of cases fitting the above selected parameters. The list of simulation parameters may include, by way of example, information about the patient, including some combination of age, ethnicity, co-morbidity, sex, or primary diagnosis of the patient. The list of simulation parameters may include, by way of example, information about some combination of identifying student roles, scripts, necessary equipment, mulage and other artifacts needed for added realism.

### A Database Module

According to some embodiments, the present invention may take the form of one or more customized simulation database modules for building a customized simulation comprising one or more modules configured to receive inputs or instructions containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and to provide data containing information about the selection of one or more simulation parameters. The one or more customized simulation database modules may be configured to store and/or exchange signaling related to one or more of the features set forth above.

### A Simulation Scenario Building Module

According to some embodiments, the present invention may take the form of one or more simulation scenario building modules for building a customized simulation comprising one or more modules configured to receive data containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals; and to provide simulation scenario building information about one or more customized simulation scenarios built for the customized simulation for educating and training nurses and other health care professionals based at least partly on the selection of the one or more simulation parameters contained in the data. The one or more simulation scenario building modules may be configured to exchange signaling related to the one or more of the features set forth above.

### A Method

According to some embodiments, the present invention may take the form of a method or process for building a customized simulation comprising steps for receiving in one or more database modules inputs or instructions containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and providing data containing information about the selection of one or more simulation parameters; and receiving in one or more simulation scenario building modules the data containing the information about the selection of the one or more simulation parameters, and providing simulation scenario building information about one or more customized simulation scenarios built for the customized simulation for educating and training nurses and other health care professionals based at least partly on the selection of the one or more simulation parameters contained in the inputs or instructions. The method may also include other steps for performing one or more of the other features set forth above.

### A Computer Program

According to some embodiments, the present invention may take the form of a computer readable storage medium having computer executable components for performing a method for building a customized simulation.

For example, the method may comprise receiving in one or more database modules inputs or instructions containing information about a selection of one or more simulation parameters stored therein, chosen by a simulation builder and based on some combination of personal preferences and specific teaching or learning objectives for building a customized simulation for educating and training nurses and other health care professionals, and providing data containing information about the selection of one or more simulation parameters.

The method may also comprise receiving in one or more simulation scenario building modules the data from the database module and providing simulation scenario building information about one or more customized simulation scenarios built for the customized simulation for educating and training nurses and other health care professionals based at least partly on the selection of the one or more simulation parameters contained in the information from the database, when executed on a computer.

The computer readable storage medium may also include performing other steps related to one or more of the other features set forth above.

Finally, the present invention provides an important contribution to the state of the art by enabling faculty/instructors to build customized simulation scenarios that align with whatever learning objectives are of interest to the faculty at the time, thus providing control of the simulation to the faculty, thereby empowering faculty to create simulations that fit his/her particular teaching objectives rather than having to create teaching objectives to fit available simulations.

### BRIEF DESCRIPTION OF THE DRAWING

FIG. 1 is a flow diagram of an overall simulation-based education paradigm according to some embodiments of the present invention.

FIG. 2 is a block diagram of a simulation module according to some embodiments of the present invention.

FIG. 3 is a diagram of a simulation customization dashboard database for designing a custom simulation according to some embodiments of the present invention.

FIG. 4 is a flowchart of a simulation paradigm according to some embodiments of the present invention.

### DESCRIPTION OF THE INVENTION

The following is a detailed description of the best mode of the present invention that is provided by way of example.

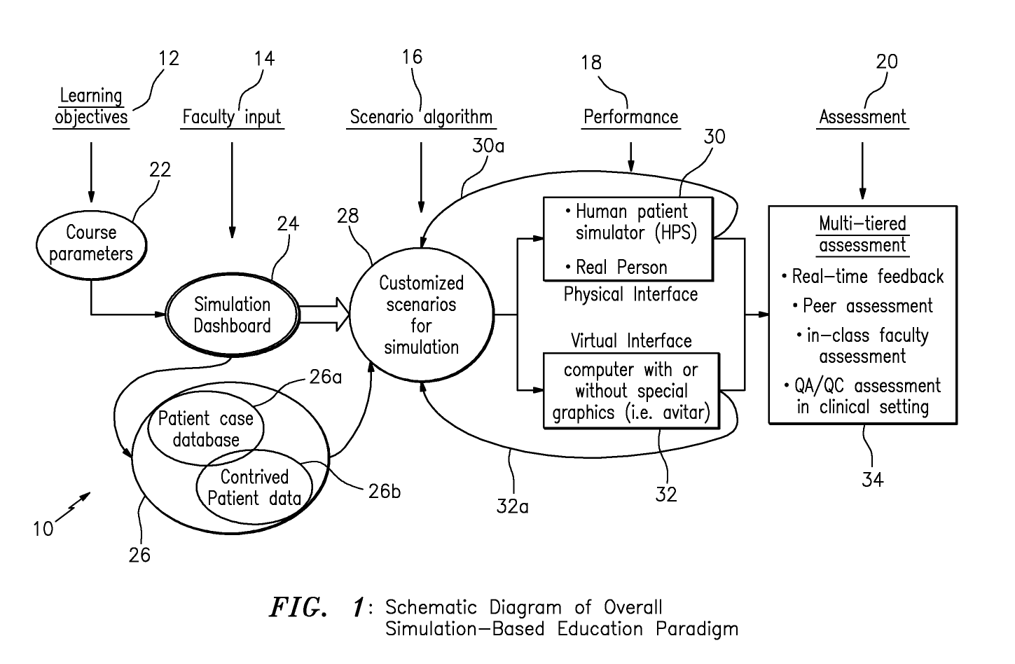

### FIG. 1

FIG. 1 is a schematic diagram of an overall simulation-based education paradigm generally indicated as 10 according to some embodiments of the present invention.

The overall simulation-based education paradigm 10 includes a series of steps that can include a step for learning objectives 12, faculty input 14, a scenario algorithm 16, performance 18 and assessment 20, each having related components for performing at least some of the functionality associated with the corresponding step.

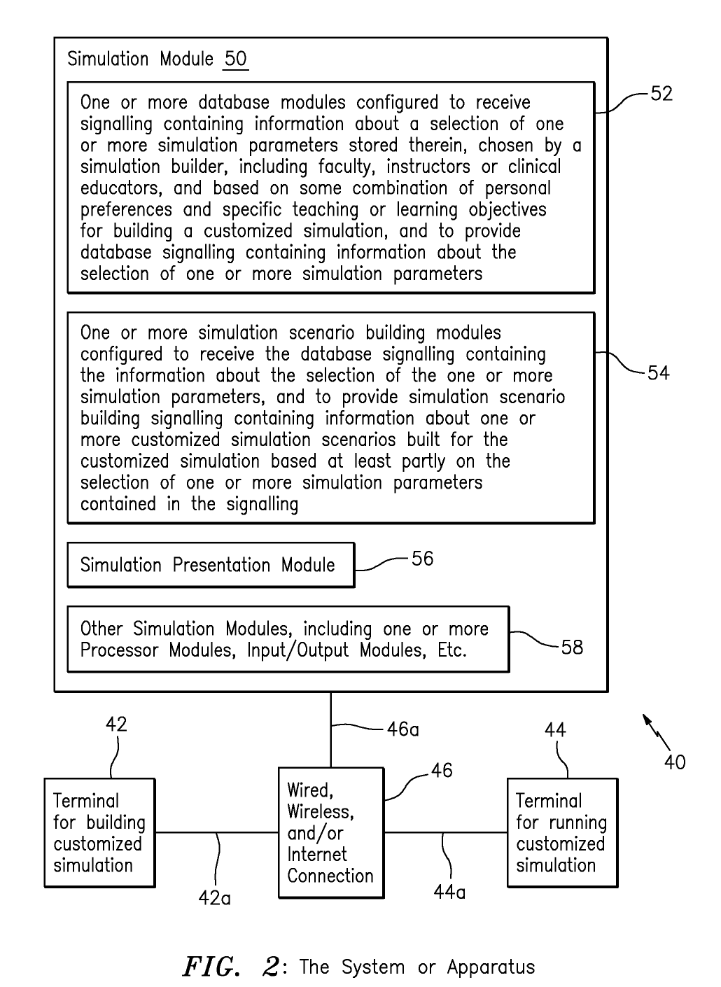

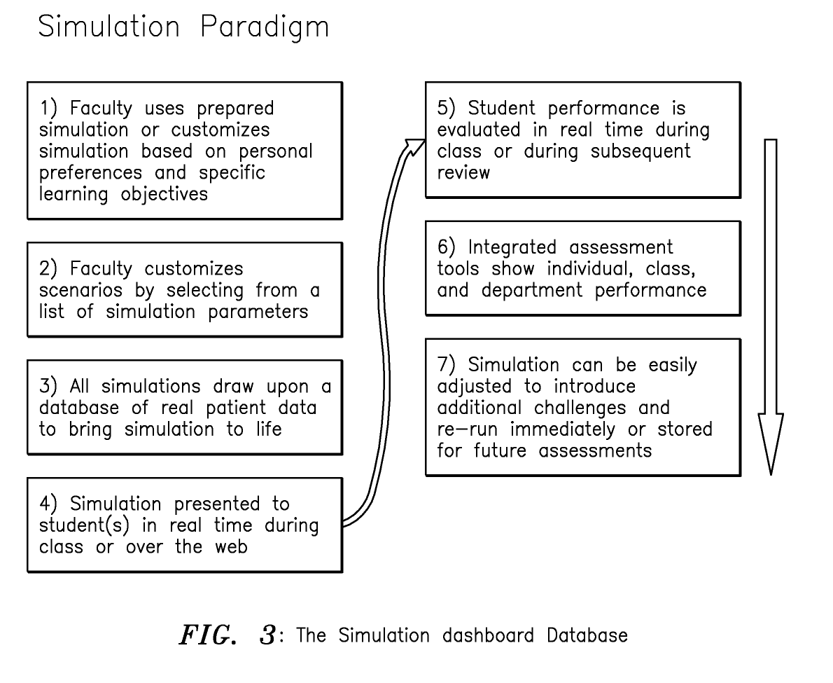

The step for learning objective 12 includes the provisioning or formulation of course parameters via a course parameters component 22. In the step for faculty input 14, a simulation dashboard component 24 receives the course parameters and is configured to select from a simulation dashboard database component 26 that may include a patient case database 26a and a contrived patient database 26b. The simulation dashboard database component 26 is shown and described in more detail in relation to FIG. 3. The simulation dashboard component 24 may be configured as a menu-driven graphical user interface (GUI) for cooperating with a terminal 42 (see FIG. 2) that provides a series of GUI prompts to a faculty member with a series of requests for providing inputs to the customized scenarios component 28 to build the customized scenarios for educating and training nurses and other health care professionals. The faculty inputs 14 are provided as data inputs or instructions and selected from the patient case database 26a and the contrived patient database 26b to the scenario algorithm 16 that forms part of the customized scenarios component 28, where the customized scenarios component 28 for simulation is configured to formulate the customized scenarios for educating and training nurses and other health care professionals according to the present invention. Again, see FIG. 3 which shows an example of a simulation customization dashboard showing an example of such inputs that may be selected by the faculty member using the menu-driven GUI. The customized scenarios component 28 is configured to provide customized scenarios or simulations that are used as a part of the step for performance 18 by the student, and may include, by way of example, performing the customized scenarios via a physical interface component 30 and/or a virtual interface component 32, where the physical interface component 30 may be configured with a human patient simulator (HPS) and/or a real person, and where the virtual interface component 32 may be configured with a computer with or without special graphics (i.e., avatar). The results of the performance 18 of the customization scenario for educating and training nurses and other health care professionals may be feedback from either the physical interface component 30 via the path 30a or the virtual interface component 32 via the path 33a to the customized scenarios component 28 so as to formulate new customized scenarios that may include increasingly complex customized scenarios. The scope of the invention is intended to include the formulation of the new customized scenarios based on either (1) new faculty inputs or (2) a pre-programmed automated formulation that depends of the results of the performance. The results of the performance 18 by the student is provided to the step for the assessment 20, that may include a multi-tiered assessment component 34 using a real-time feedback having peer assessment or in-class faculty assessment, and/or using QA/QC assessment in a clinical setting.

### FIG. 2

### The Simulation Module 50 for Building Scenarios

FIG. 2 shows a simulation system or apparatus generally indicated as 40 having the basic building blocks for implementing overall simulation-based education paradigm 10 shown in FIG. 1 according to some embodiments of the present invention. The simulation system or apparatus 40 is configured to include one or more terminals 42, 44 and a simulation module 50 for building scenarios. The simulation module 50 may be connected to the one or more terminals 42, 44 for building the customized simulation scenarios, e.g. by the simulation builder, including the faculty, instructors or clinical educators, as well as for conducting customized simulation scenarios e.g. by the simulation builder, including faculty, instructors or clinical educators, and the student. By way of example, the connection may include a wired, wireless and/or Internet connection 46, although the scope of the invention is not intended to be limited to the type or kind of connection either now known or later developed in the future. The one or more terminals 42, 44 may include desktops, laptops, personal digital assistants (PDA), mobile phone, node, point, terminal or device, dump terminals, as well as other types or kinds of electronic devices either now known or later developed in the future. The one or more terminals 42, 44, the wired, wireless and/or Internet connection 20 and the simulation module 50 exchange corresponding signaling via signaling paths 42a, 44b and 46a to implement functionality associated with the present invention.

The simulation module 50 according to some embodiments of the present invention may be configured for formulating the customized scenarios 28 (FIG. 1) for simulation. The simulation module 50 may include one or more database modules 52 in combination with one or more simulation scenario building modules 54.

By way of example, in operation the one or more database modules 52 may be configured to receive signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals. The signaling may be in the form of inputs or instructions from, e.g., the simulation dashboard 24 that are based at least partly on the inputs or instructions provided by simulation builder. The one or more database modules 52 may also be configured to provide database signaling containing information about the selection of one or more simulation parameters. By way of example, the one or more database modules 52 may be configured to receive the signaling as part of signaling responses to the menu-driven GUI prompts provided by the faculty member via keyboard or other suitable input device from, e.g., the terminal 42, for selecting of one or more simulation parameters stored therein. The signaling exchange between the simulation module 50 and the terminal 42 would be along signaling paths 42a and 46a for implementing this functionality. By way of example, the one or more simulation scenario building modules 54 may be configured to receive the signaling from the one or more database modules 52 based at least in part on the response by the faculty member to the menu-driven GUI prompts, consistent with that described herein. The one or more database modules 52 may include, or form part of, the simulation dashboard database 26 shown in relation to the step for faculty input in FIG. 1. The scope of the invention is intended to include implementing the one or more database modules 52 as described herein, alone or together with the one or more simulation scenario building modules 54, consistent with that described herein.

By way of example, in operation the one or more simulation scenario building modules 54 may be configured to receive the database signaling containing the information about the selection of the one or more simulation parameters. The one or more simulation scenario building modules 54 may also be configured to provide simulation scenario building signaling containing information about one or more customized simulation scenarios built for the customized simulation for educating and training nurses and other health care professionals based at least partly on the selection of the one or more simulation parameters contained in the database signaling. By way of example, the one or more simulation scenario building modules 54 may be configured to implement the menu-driven GUI and provide the signaling to the one or more database modules 52 based at least in part on the response by the faculty member to the menu-driven GUI prompts, consistent with that described herein. Embodiments are also envisioned in which the simulation module 50 includes a simulation dashboard module for implementing the menu-driven GUI that may be configured to provide the menu-driven GUI prompts to the faculty member, and provide the signaling to the one or more database modules 52 based at least in part on the response by the faculty member to the menu-driven GUI prompts, consistent with that described below. The one or more simulation scenario building modules 54 may include, or form part of, the customized scenarios component 28 shown in relation to the step for scenario algorithm in FIG. 1. The scope of the invention is intended to include implementing the one or more simulation scenario building modules 54 as described herein, alone or together with the one or more database modules 52, consistent with that described herein.

The one or more database modules 52 and simulation scenario building modules 54 may be implemented by a person skilled in the art to provide for the necessary signaling exchange in order to perform the functionality described herein using hardware, software or some combination thereof either now known or later developed in the future as described in further detail below. Embodiments are also envisioned in which the one or more database modules 52 and simulation scenario building modules 54 are implemented, or form part of, the same module or modules.

Although the present invention is described by way of example in relation to educating and training nurses and other health care professionals, the scope of the invention is intended to including building simulations according to the present invention for educating and training other types or kind of personnel and professionals in other types or kinds of industries either now known or later developed in the future.

### FIG. 3

### A Database Module 52

The present invention is also intended to take the form of the one or more database modules 52, that may include a simulation customization dashboard database configured to store the simulation parameters to be chosen by the simulation builder and based on some combination of the personal preferences and specific teaching or learning objectives for building the customized simulation for educating and training nurses and other health care professionals. The simulation customization dashboard database may be configured to store the real and contrived patient data, as described above in relation to components 26a, 26b in FIG. 1.

By way of example, as shown in FIG. 3 the list of simulation parameters may includes, by way of example, some combination of a level of nurse or healthcare professional training, a parameter related to an age of a patient, one or more clinical parameters of the patient, one or more social parameters of the patient, one or more care facility parameters, a level of support available, a care circumstance, disease categories or parameters, simulation objectives, or a case selection.

The level of nurse training may include, by way of example, a pre-licensure category which includes 1st level or 2nd level nursing student, and a licensed practitioner category that will include employee/resident competency-maintenance or competency-new area.

The parameter related to an age of the patient may include, by way of example, neonate, pediatric, adolescent, young adult, middle age, near elderly, and elderly.

The one or more clinical parameters of the patient may include, by way of example, verbal/non-verbal, conscious/unconscious, know/unknown history, chronic/acute condition, known/unknown diagnosis.

The one or more social parameters of the patient may include, by way of example, some combination of English/non-English speaking, indigent, cooperative/uncooperative.

The one or more care facility parameters may include, by way of example, some combination of a teaching hospital, a suburban hospital, an emergency clinic, ambulatory care, long term/rehabilitation and home care.

The level of support available includes, by way of example, some combination of paraprofessional and professional support.

The care circumstance may include, by way of example, some combination of a single patient, multiple patients, emergency care, in-patient care, critical care, and triage.

The health and illness parameters may include some combination of disease and situation specific conditions such as: medication/substance abuse; medical surgical issues; psychiatric mental health issues; specialized conditions and population specific issues.

The simulation objectives may include, by way of example, some combination of assessment, comfort, diagnosis, management, hand-off and education of patient and/or their family.

The care selection may include, by way of example, a system that provides a suite of cases fitting the above selected parameters.

The list of simulation parameters may include, by way of example, information about the patient, including some combination of age, ethnicity, co-morbidity, sex, or primary diagnosis of the patient.

The list of simulation parameters may include, by way of example, information about some combination of identifying student roles, scripts, necessary equipment, mulage and other artifacts needed for added realism.

The scope of the invention is also intended to include other types and kinds of simulation parameters either now known or later developed in the future, including other types and kinds of simulation parameters for educating and training other types or kind of personnel and professionals in other types or kinds of industries either now known or later developed in the future.

### The Simulation Scenario Building Module 54 and Simulation Dashboard

The one or more simulation scenario building modules 54 may be configured to provide or implement a simulation dashboard so as to provide the GUI that may include providing menu-based signaling containing information about one or more requests for the selection of simulation parameters to be chosen by the simulation scenario builder, and receiving in responds thereto customized simulation building user-input signaling containing information about the one or more requests for the selection of simulation parameters chosen by the simulation scenario builder.

The one or more simulation scenario building modules 54 may also be configured to receive further customized simulation scenario building signaling containing information about adjusting or modifying one or more previously built customized simulation scenarios, and may be configured to provide further simulation scenario building signaling containing information about one or more adjusted or modified customized simulation scenarios, including additional challenges, built for the customized simulation based at least partly on the further customized simulation scenario building signaling.

The one or more simulation scenario building modules 54 may be configured to receive associate signaling containing information about adjusting the prepared or customized simulation scenario, and configured to determine a sequential customized simulation scenario based at least partly on the information received in the associated signaling.

The one or more simulation scenario building modules 54 may be configured to determine customized simulation scenarios that include a set of sequential customized simulation scenarios having increasingly complicated simulation scenarios.

The one or more simulation scenario building modules 54 may also be configured to provide the signaling to the one or more database modules.

### A Simulation Presentation Module 56

The simulation scenario building module 54 may comprise one or more simulation presentation modules 56 configured to provide customized simulation scenarios signaling containing information to present the customized simulation scenarios when conducting a simulation by a student or faculty during the step for performance 18 in FIG. 1. The simulation scenario building module 54 may include, or form part of, the physical interface component 30 and/or the virtual interface component 32 shown in FIG. 1, and may be implemented in relation to the terminal 44 for conducting a customized simulation in FIG. 2. The signaling exchange between the simulation module and the terminal 44 would be along signaling paths 44a and 46a for implementing this functionality.

The one or more simulation presentation modules 56 may also be configured to provide the customized simulation scenarios in the simulation to one or more students in real time during class or over the Internet via an interactive exchange.

The one or more simulation presentation modules 56 may also be configured to receive simulation scenarios feedback signaling containing information about a response to the one or more customized simulation scenarios being presented in the simulation. The simulation scenarios feedback signaling may contain information about the response to the one or more customized simulation scenarios being presented in the simulation and is evaluated in real time during class or during a subsequent review. The one or more simulation presentation modules 56 may also be configured to run the one or more adjusted or modified customized simulation scenarios immediately or in the future for further assessment. The one or more simulation presentation modules may be configured to be web enabled to upload the customized simulation scenarios for remote access, including via a remote computer, such as terminal 44. The customized simulation scenarios signaling may contain information about using a simulation Human Patient Simulator (HPS). The customized simulation scenarios signaling may contain information about some combination of development of student evaluation methods, event logs and debriefing questions. The one or more simulation presentation modules 56 may be configured to retrieve simulation data for analysis, including in a face-to-face teaching environment, as indicated in steps 18 and 20 of FIG. 1.

### Other Modules 58

The simulation module 50 may also be configured with one or more other modules 58 for implementing other functionality that does not form part of the underlying invention, including input/output functionality, control processing functionality, etc., that would be appreciated by a person skilled in the art.

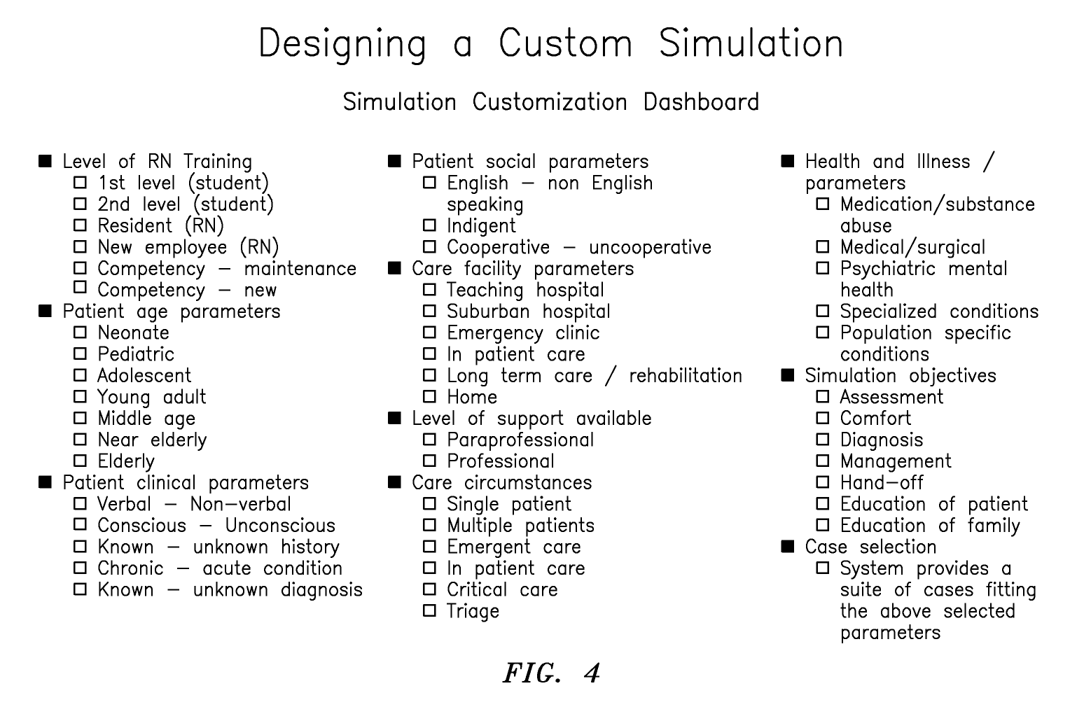

### FIG. 4

### The Method

FIG. 4 shows, by way of example, a method for a simulation paradigm for educating and training nurses and other health care professionals according to some embodiments having steps 1 to 7, including some combination of the following: (1) where the faculty uses prepared simulation or customized simulation based on personal preferences and specific learning objectives; (2) where the faculty customizes scenarios by selecting from a list of simulation parameters; (3) where all simulations draw upon a database of real patient data to bring simulation to life; (4) where a simulation is presented to student(s) in real time during class or over the web; (5) where student performance is evaluated in real time during class or during subsequent review; (6) where integrated assessment tools show individual, class, and department performance; and (7) where simulation can be easily adjusted to introduce additional challenges and re-run immediately or stored for future assessment.

### Implementation of the Functionality of The Database and Simulation Scenario Building Modules 52, 54

The scope of the invention is not intended to be limited to the specific implementation of the module shown in FIG. 1 or 2 in order to provide the functionality and signaling exchanges that form part of implementing according to the present invention.

By way of example, consistent with that described herein, the functionality of the modules, including but not limited to modules identified by reference labels 24, 28, 50, 52, 54, 56, may be implemented using other configurations of hardware, software, firmware, or a combination thereof, although the scope of the invention is not intended to be limited to any particular embodiment thereof. In a typical software implementation, the appliance controller may include one or more microprocessor-based architectures having a microprocessor or microcontroller, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the circuit module being standalone, as shown, or in the combination with other circuitry for implementing another module.

All of the aforementioned modules are configured to exchange signaling to both receive and/or provide information for implementing the present invention.

Furthermore, embodiments are envisioned in which other arrangements using other components either now known or later developed in the future that may be used to achieve or implement the desired functionality according to the present invention.

### Alternative Embodiment

Embodiments are also envisioned in which the technique according to the present invention is applied to clinical education and training based on a simulation strategy becomes a standardized infrastructure for creating scenarios and conducting simulations. In such a case, embodiments are envisioned in which a third party in the free market place would be free to build actual customized simulation scenarios based on patient data, and such third party customized simulation scenario applications could be put in a format compatible to work in conjunction with the technique according to the present invention, so as to make applications available to all users of the present invention, similar to the idea of iPods and “ap stores.” For example, if a nurse educator at the University of Guam develops a simulation believed to be broadly valuable, then that nurse educator could put the simulation in a compatible format to the manner in which customized simulations are formatted according to the present invention and make the application available to all users of the present invention. In effect, the customized simulation scenario could be sold as an application in the open market place for use by purchasers of embodiments of the present invention.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. A simulation module comprising:
one or more database modules configured to receive signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and to provide database signaling containing information about the selection of one or more simulation parameters; and
one or more simulation scenario building modules configured to receive the database signaling containing the information about the selection of the one or more simulation parameters, and to provide simulation scenario building signaling containing information about one or more customized simulation scenarios built for the customized simulation for educating and training nurses and other health care professionals based at least partly on the selection of the one or more simulation parameters contained in the signaling.

2. A simulation module according to claim 1, wherein the one or more database modules comprises a simulation customization dashboard database configured to store the simulation parameters to be chosen by the simulation builder and based on some combination of the personal preferences and specific teaching or learning objectives for building the customized simulation.

3. A simulation module according to claim 2, wherein the simulation customization dashboard database is configured to store real patient data.

4. A simulation module according to claim 1, wherein the database signaling includes the real patient data.

5. A simulation module according to claim 1, wherein the one or more simulation scenario building modules is configured to receive the signaling from the one or more database modules.

6. A simulation module according to claim 1, wherein the one or more simulation scenario building modules comprises a dashboard module configured to provide a graphical user interface that includes providing menu-based signaling containing information about one or more requests for the selection of simulation parameters to be chosen by the simulation builder, and receiving in response thereto customized simulation building user-input signaling containing information about the request for the selection of simulation parameters chosen by the simulation builder.

7. A simulation module according to claim 1, wherein the one or more simulation scenario building modules comprises a customized simulation scenarios database configured to store the simulation scenario building signaling containing information about the one or more customized simulation scenarios built for the customized simulation.

8. A simulation module according to claim 1, wherein the one or more simulation scenario building modules is configured to receive further customized simulation scenario building signaling containing information about adjusting or modifying one or more previously built customized simulation scenarios, and to provide further simulation scenario building signaling containing information about one or more adjusted or modified customized simulation scenarios, including additional challenges, built for the customized simulation based at least partly on the further customized simulation scenario building signaling.

9. A simulation module according to claim 1, wherein the one or more simulation scenario building modules is configured to receive associated signaling containing information about adjusting the prepared or customized simulation scenario, and determine a sequential customized simulation scenario based at least partly on the information received in the associated signaling.

10. A simulation module according to claim 1, wherein the one or more simulation scenario building modules is configured to determine customized simulation scenarios that include a set of sequential customized simulation scenarios having increasingly complicated scenarios.

11. A simulation module according to claim 1, wherein the simulation module comprises one or more simulation presentation modules configured to provide customized simulation scenarios signaling containing information to present the customized simulation scenarios when conducting a simulation.

12. A simulation module according to claim 11, wherein the one or more simulation presentation modules is configured to provide the customized simulation scenarios in the simulation to one or more students in real time during class or over the Internet.

13. A simulation module according to claim 11, wherein the one or more simulation presentation modules is configured to receive simulation scenarios feedback signaling containing information about a response to the one or more customized simulation scenarios being presented in the simulation.

14. A simulation module according to claim 11, wherein the simulation scenarios feedback signaling containing information about the response to the one or more customized simulation scenarios being presented in the simulation is evaluated in real time during class or during a subsequent review.

15. A simulation module according to claim 11, wherein the one or more simulation presentation modules is configured to conduct the one or more adjusted or modified customized simulation scenarios immediately or in the future for further assessment.

16. A simulation module according to claim 11, wherein the one or more simulation presentation modules is configured to be web enabled to upload the customized simulation scenarios for remote access, including via a remote computer.

17. A simulation module according to claim 11, wherein the customized simulation scenarios signaling contains information about using a Human Patient Simulator (HPS).

18. A simulation module according to claim 11, wherein the customized simulation scenarios signaling contains information about some combination of development of student evaluation methods, event logs and debriefing questions.

19. A simulation module according to claim 11, wherein the one or more simulation presentation modules is configured to retrieve simulation data for analysis, including in a face-to-face teaching environment.

20. A simulation module according to claim 1, wherein the list of simulation parameters includes some combination of a level of nurse training, a parameter related to an age of a patient, one or more clinical parameters of the patient, one or more social parameters of the patient, one or more care facility parameters, a level of support available, a care circumstance, disease categories or parameters, simulation objectives, a case selection, or other parameter.

21. A simulation module according to claim 20, wherein the level of nurse training includes a pre-licensure category which includes 1^{st} level or 2nd level nursing student, and a licensed practitioner category that will include new employee/resident, competency-maintenance, or competency-new area.

22. A simulation module according to claim 20, wherein the parameter related to an age of the patient includes neonate, pediatric, adolescent, young adult, middle age, near elderly, elderly.

23. A simulation module according to claim 20, wherein the one or more clinical parameters of the patient, includes verbal/non-verbal, conscious/unconscious, know/unknown history, chronic/acute condition, known/unknown diagnosis.

24. A simulation module according to claim 20, wherein the one or more social parameters of the patient includes some combination of English/non-English speaking, indigent, cooperative/uncooperative.

25. A simulation module according to claim 20, wherein the one or more care facility parameters includes some combination of a teaching hospital, a suburban hospital, an emergency clinic, ambulatory, long term care/rehabilitation and home care.

26. A simulation module according to claim 20, wherein the level of support available includes some combination of paraprofessional and professional support.

27. A simulation module according to claim 20, wherein the care circumstance includes some combination of a single patient, multiple patients, emergency care, in-patient care, critical care and triage.

28. A simulation module according to claim 20, wherein the health and illness parameters includes some combination of disease and situation specific conditions such as: medication/substance abuse; medical/surgical issues; psychiatric mental health issues; specialized conditions and population specific issues.

29. A simulation module according to claim 20, wherein the simulation objectives includes some combination of assessment, comfort, diagnosis, management, hand-off and education of patient and/or their families.

30. A simulation module according to claim 20, wherein the care selection includes a system that provides a suite of cases fitting the above selected parameters.

31. A simulation module according to claim 20, wherein the list of simulation parameters includes information about the patient, including some combination of age, ethnicity, co-morbidity, sex, or primary diagnosis of the patient.

32. A simulation module according to claim 1, wherein the list of simulation parameters includes information about some combination of identifying student roles, scripts, necessary equipment, mulage and other artifacts needed for added realism.

33. One or more customized simulation database modules for building a customized simulation comprising:
one or more modules configured to receive signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and to provide database signaling containing information about the selection of one or more simulation parameters.

34. One or more customized simulation database modules according to claim 33, wherein the one or more customized simulation database modules comprises a simulation customization dashboard database configured to store the simulation parameters to be chosen by the simulation builder and based on some combination of the personal preferences and specific teaching or learning objectives for building the customized simulation.

35. One or more customized simulation database modules according to claim 33, wherein the simulation customization dashboard database is configured to store real patient data.

36. One or more customized simulation database modules according to claim 33, wherein the database signaling includes the real patient data.

37. One or more simulation scenario building modules for building a customized simulation comprising:
one or more modules configured to receive database signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals; and to provide simulation scenario building signaling containing information about one or more customized simulation scenarios built for the customized simulation for educating and training nurses and other health care professionals based at least partly on the selection of the one or more simulation parameters contained in the database signaling.

38. One or more simulation scenario building modules according to claim 37, wherein the one or more modules is configured to provide further signaling containing information about a request for the selection of simulation parameters to be chosen by the simulation builder, and to receive customized simulation scenario building signaling containing information about the request for the selection of simulation parameters chosen by the simulation builder.

39. One or more simulation scenario building modules according to claim 37, wherein the one or more modules comprises a customized simulation scenarios database configured to store the simulation scenario building signaling containing information about the one or more customized simulation scenarios built for the customized simulation.

40. One or more simulation scenario building modules according to claim 37, wherein the one or more modules is configured to receive further customized simulation scenario building signaling containing information about adjusting or modifying one or more previously built customized simulation scenarios, and to provide further simulation scenario building signaling containing information about one or more adjusted or modified customized simulation scenarios, including additional challenges, built for the customized simulation based at least partly on the further customized simulation scenario building signaling.

41. One or more simulation scenario building modules according to claim 37, wherein the one or more modules is configured to receive associated signaling containing information about adjusting the prepared or customized simulation scenario, and determine a sequential customized simulation scenario based at least partly on the information received in the associated signaling.

42. One or more simulation scenario building modules according to claim 37, wherein the one or more modules is configured to determine customized simulation scenarios that include a set of sequential customized simulation scenarios having increasingly complicated scenarios.

43. A method for building a customized simulation comprising:
receiving in one or more database modules signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and providing database signaling containing information about the selection of one or more simulation parameters; and
receiving in one or more simulation scenario building modules the database signaling containing the information about the selection of the one or more simulation parameters, and providing simulation scenario building signaling containing information about one or more customized simulation scenarios built for the customized simulation for educating and training nurses and other health care professionals based at least partly on the selection of the one or more simulation parameters contained in the signaling.

44. A method according to claim 43, wherein the method comprises providing from the one or more simulation scenario building modules the signaling to the one or more database modules.

45. A method according to claim 43, wherein the method comprises providing from the one or more simulation scenario building modules further signaling containing information about a request for the selection of simulation parameters to be chosen by the simulation builder, and to receive customized simulation scenario building signaling containing information about the request for the selection of simulation parameters chosen by the simulation builder.

46. A method according to claim 43, wherein the method comprises storage in a customized simulation scenarios database of the one or more simulation scenario building modules the simulation scenario building signaling containing information about the one or more customized simulation scenarios built for the customized simulation.

47. A method according to claim 43, wherein the method comprises receiving in the one or more simulation scenario building modules further customized simulation scenario building signaling containing information about adjusting or modifying one or more previously built customized simulation scenarios, and providing further simulation scenario building signaling containing information about one or more adjusted or modified customized simulation scenarios, including additional challenges, built for the customized simulation based at least partly on the further customized simulation scenario building signaling.

48. A method according to claim 43, wherein the method comprises receiving in the one or more simulation scenario building modules associate signaling containing information about adjusting the prepared or customized simulation scenario, and determine a sequential customized simulation scenario based at least partly on the information received in the associated signaling.

49. A method according to claim 43, wherein the method comprises determining in the one or more simulation scenario building modules customized simulation scenarios that include a set of sequential customized simulation scenarios having increasingly complicated scenarios.

50. A computer readable storage medium having computer executable components for performing a method for building a customized simulation comprising:
receiving in one or more database modules signaling containing information about a selection of one or more simulation parameters stored therein, chosen by a simulation builder, including faculty, instructors or clinical educators, and based on some combination of personal preferences and specific teaching or learning objectives for building a customized simulation for educating and training nurses and other health care professionals, and providing database signaling containing information about the selection of one or more simulation parameters; and
receiving in one or more simulation scenario building modules the database signaling containing the information about the selection of the one or more simulation parameters, and providing simulation scenario building signaling containing information about one or more customized simulation scenarios built for the customized simulation for educating and training nurses and other health care professionals based at least partly on the selection of the one or more simulation parameters contained in the signaling, when executed on a computer.
